(19) United States
(12) Patent Application Publication
(10) Pub. No.: US 2016/0196585 A1
(43) Pub. Date: Jul. 7, 2016

(54) METHOD AND SYSTEM FOR PROVIDING PROMOTION PLATFORM TO EXPOSE INFORMATION OF THE MOBILE APPLICATION

(71) Applicant: NHN Entertainment Corporation, Seongnam-si (KR)

(72) Inventor: Eun Young SONG, Seongnam-si (KR)

(21) Appl. No.: 14/836,589

(22) Filed: Aug. 26, 2015

(30) Foreign Application Priority Data
Jan. 7, 2015 (KR) 10-2015-0002055

(51) Int. Cl. G06Q 30/02

(52) U.S. Cl. CPC G06Q 30/0267

(57) ABSTRACT

Provided is a promotion platform providing method and system that may display information of a mobile application. The method includes receiving registration request signals from service provider terminals, the registration request signals each including an identifier of a mobile application to be registered in a computer-implemented promotion platform; registering, at the computer-implemented promotion platform, a plurality of different mobile applications based on the registration request signals; determining, at the computer-implemented promotion platform, a target application associated with a first application and a content item for a user to enter the computer-implemented promotion platform through the first application; and displaying an application (App) information screen to the user having entered a promotion platform through the first application among the plurality of different mobile applications. The App information screen includes a content area and a promotion area associated with at least one of the plurality of different mobile applications.

### CROSS-REFERENCE TO RELATED APPLICATION

This application claims priority from and the benefit of Korean Patent Application No. 10-2015-0002055, filed on Jan. 7, 2015, which is hereby incorporated by reference for all purposes as if fully set forth herein.

### BACKGROUND

1. Field

Exemplary embodiments of the present invention relate to a promotion platform providing method and system that may display information of a mobile application by sharing user traffic between a plurality of different mobile applications.

2. Discussion of the Background

Even during a day, more than 100 mobile applications (mobile Apps) are released and tens of or hundreds of applications (Apps) are registered to an application store (Appstore). Irrespective of the release of many new mobile Apps in the market, users generally utilize Apps that they usually use. Accordingly, new Apps need to be promoted to gain users' attention. However, relatively high market cost is required and a promotion of a new App to an affiliated mobile App may only achieve a temporary effect.

For example, a promotion of a new game App is generally implemented with respect to existing game Apps having secured users using a cross game promotion (CGP). In this example, users may play the new game App temporarily during a promotion period using the CGP and thus, frequently leave the new game App a couple of days later. Further, a service provider of the new game App is looking for a counter party game for the CGP every time and may also have difficulty in negotiating a schedule or a condition based on an opinion gap with a service provider of an existing game App.

### SUMMARY

An exemplary embodiment provides a promotion platform providing method and system that may provide a space in which different mobile Apps may gather to share traffic of users of the mobile Apps and to be mutually advertised.

An exemplary embodiment provides a promotion platform providing method and system that may attract a new user through Apps registered to a promotion platform and may enable an idle user to return.

An exemplary embodiment provides a promotion platform providing method and system that may attract an actual user, for example, a genuine gamer instead of attracting a temporary user by providing a compensation to a user having performed a mission in an App of which a promotion and an advertisement are ongoing through a promotion platform and by inducing the user to continuously use the App.

An exemplary embodiment provides a promotion platform providing method and system that may display information associated with different mobile Apps and retargeting information together through a promotion platform.

Additional features of the invention will be set forth in the description which follows, and in part will be apparent from the description, or may be learned by practice of the invention.

An exemplary embodiment discloses a method of providing a computer-implemented promotion platform by a promotion platform service providing apparatus, the method including: receiving registration request signals from service provider terminals, the registration request signals each including an identifier of a mobile application to be registered in a computer-implemented promotion platform; registering, at the computer-implemented promotion platform, a plurality of different mobile applications based on the registration request signals; determining, at the computer-implemented promotion platform, a target application associated with a first application and a content item for a user to enter the computer-implemented promotion platform through the first application; and displaying an application (App) information screen to the user having entered a promotion platform through the first application among the plurality of different mobile applications. The App information screen includes a content area and a promotion area associated with at least one of the plurality of different mobile applications, and the promotion area is associated with the target application, and the content area is associated with the content item.

An exemplary embodiment also discloses a non-transitory computer-readable storage medium including a program that, when executed by one or more processors of a computer-implemented promotion platform providing apparatus, causes the computer-implemented promotion platform providing apparatus to perform: receiving registration request signals from service provider terminals, the registration request signals each including an identifier of a mobile application to be registered in a computer-implemented promotion platform; registering, at the computer-implemented promotion platform, a plurality of different mobile applications based on the registration request signals; determining, at the computer-implemented promotion platform, a target application associated with a first application and a content item for a user to enter the computer-implemented promotion platform through the first application; and displaying an application (App) information screen to the user having entered a promotion platform through the first application among the plurality of different mobile applications. The App information screen includes a content area and a promotion area associated with at least one of the plurality of different mobile applications, and the promotion area is associated with the target application, and the content area is associated with the content item.

An exemplary embodiment also discloses a promotion platform system including: a registration request transceiver configured to receive registration request signals from service provider terminals, the registration request signals each including an identifier of a mobile application to be registered in a computer-implemented promotion platform of the promotion platform system; a register configured to register a plurality of different mobile applications to the computer-implemented promotion platform based on the registration request signals; a processor including a promotion matching module configured to determine a target application associated with a first application and a content item for a user to enter the computer-implemented promotion platform through the first application; and a display controller configured to display an application (App) information screen to the user having entered a promotion platform through the first application among the plurality of different mobile applications. The App information screen includes a content area and a promotion area associated with at least one of the plurality of different mobile applications, and the promotion area is associated with the target application, and the content area is associated with the content item.

According to an exemplary embodiment, Apps may be mutually advertised by sharing traffic of users of each App.

According to an exemplary embodiment, it is possible to attract a new user through Apps registered to a promotion platform and to enable an idle user to return using the promotion platform.

According to an exemplary embodiment, it is possible to attract not a temporary user but a genuine user by providing a compensation to a user having performed a mission in an App of which a promotion and an advertisement are ongoing through a promotion platform and by inducing the user to continuously use the App.

According to an exemplary embodiment, it is possible to display information associated with different mobile Apps and retargeting information together through a promotion platform.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a diagram illustrating a process of sharing traffic of users of different applications in a promotion platform system according to an exemplary embodiment.

FIG. 2 is a diagram illustrating a user terminal, a mobile application, and a promotion platform system according to an exemplary embodiment.

FIG. 3 is a block diagram illustrating a configuration of a promotion platform system according to an exemplary embodiment.

FIG. 4 is a flowchart illustrating a method of providing a promotion platform according to an exemplary embodiment.

FIG. 5 illustrates a registration screen on which a mobile App participates in a promotion platform as an inventory App according to an exemplary embodiment.

FIG. 6 illustrates a registration screen on which a mobile App participates in a promotion platform as a target App according to an exemplary embodiment.

FIG. 7 illustrates a screen on which a mobile App registered to a promotion platform provides a platform icon according to an exemplary embodiment.

FIG. 8 illustrates an App information screen displayed to a user in response to a user entry in a promotion platform through an App in execution according to an exemplary embodiment.

FIG. 9 is a block diagram illustrating a configuration of a promotion platform system according to an exemplary embodiment.

FIG. 10 is a flowchart illustrating a method of displaying information data of mobile Apps registered to a promotion platform according to an exemplary embodiment.

FIG. 11 illustrates an App information screen for displaying information data of a mobile App registered to a promotion platform and content associated with the mobile App according to an exemplary embodiment.

FIG. 12 illustrates an App information screen for displaying information data of a registered mobile App, content, and external information according to an exemplary embodiment.

FIG. 13 illustrates a process of determining display priorities of mobile applications to be displayed on an App information screen according to an exemplary embodiment.

FIG. 14 illustrates a process of determining display priorities of external information and contents associated with mobile applications to be displayed on an App information screen according to an exemplary embodiment.

FIG. 15 is a block diagram illustrating a configuration of a computer system according to an exemplary embodiment.

### DETAILED DESCRIPTION OF THE ILLUSTRATED EMBODIMENTS

Exemplary embodiments of the present invention will be described in detail with reference to the accompanying drawings. These example embodiments will be described in detail for those skilled in the art in order to practice the present invention. It should be appreciated that various example embodiments of the present invention are different but do not have to be exclusive. For example, specific shapes, configurations, and characteristics described in an example embodiment of the present invention may be implemented in another example embodiment without departing from the spirit and the scope of the present invention. In addition, it should be understood that position and arrangement of individual components in each disclosed example embodiment may be changed without departing from the spirit and the scope of the present invention. Therefore, a detailed description described below should not be construed as being restrictive. In addition, the scope of the present invention is defined only by the accompanying claims and their equivalents if appropriate. Similar reference numerals will be used to describe the same or similar functions throughout the accompanying drawings. It will be understood that for the purposes of this disclosure, “at least one of X, Y, and Z” can be construed as X only, Y only, Z only, or any combination of two or more items X, Y, and Z (e.g., XYZ, XYY, YZ, ZZ).

The terminology used herein is for the purpose of describing example embodiments only and is not intended to be limiting of the invention. As used herein, the singular forms “a”, “an”, and “the” are intended to include the plural forms as well, unless the context clearly indicates otherwise. It will be further understood that the terms “comprises” and/or “comprising”, when used in this specification, specify the presence of stated features, integers, steps, operations, elements and/or components, but do not preclude the presence or addition of one or more other features, integers, steps, operations, elements, components, and/or groups thereof.

It will be understood that when an element is referred to as being “connected to” another element, it can be directly connected to the other element, or intervening elements may be present.

Hereinafter, various exemplary embodiments will be described in detail with reference to the accompanying drawings.

An exemplary embodiment may be applicable to a mobile platform system that may share user traffic between a plurality of different mobile applications. For example, an exemplary embodiment may be applicable to a system that gathers game Apps and performs a promotion and an advertisement of a target game in each App. In addition to the game Apps, an exemplary embodiment may be applicable to any type of mobile platform that gathers a variety of mobiles Apps such as a map related App and a webtoon (online cartoons serviced on a web-based platform) related App and performs an App advertisement through the gathered Apps.

In an exemplary embodiment, information data may indicate promotion information associated with a mobile application and advertisement information such as an event. Hereinafter, a description will be made by employing a promotion and an advertisement of a mobile application as an example of information data.

The terms “application” and “App” may be interchangeably used throughout the specification.

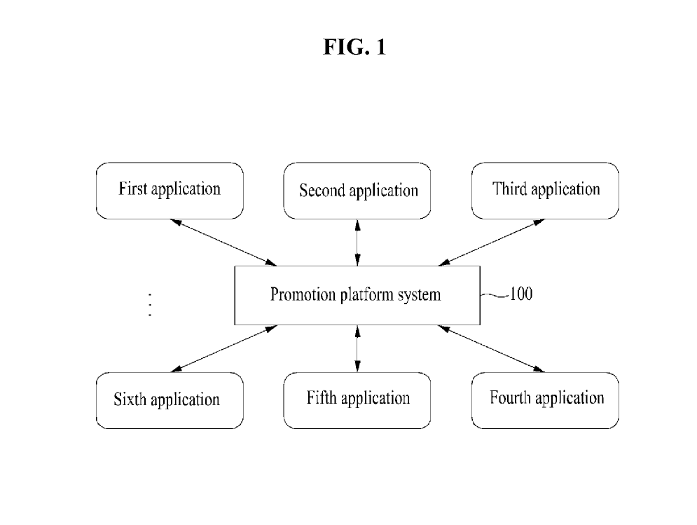

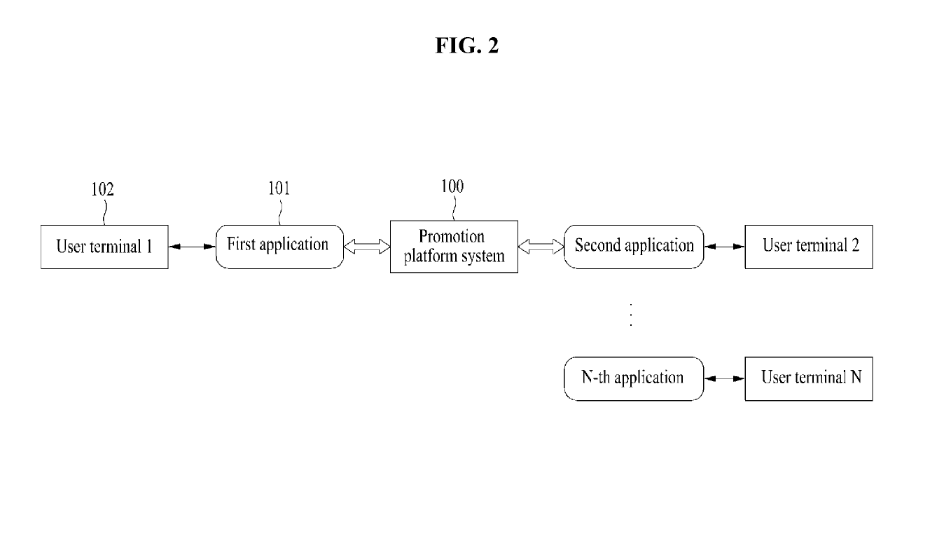

FIG. 1 is a diagram illustrating a process of sharing traffic of users of different applications in a promotion platform system according to an exemplary embodiment, and FIG. 2 is a diagram illustrating a user terminal, a mobile application, and a promotion platform system according to an exemplary embodiment. Referring to FIG. 1 and FIG. 2, a mobile application may be installed in a user terminal (not shown), and a user interface may be provided between the user terminal and the promotion platform system 100 through the installed mobile application. In FIG. 1 and FIG. 2, indicators with arrowheads may indicate that data may be transmitted and received between the promotion platform system 100 and the user terminal over a wired/wireless network.

Referring to FIG. 1, the promotion platform system 100 refers to a system that provides a platform to enable mobile applications to mutually display information data therebetween by sharing a user between the mobile applications using analytics, and may register a plurality of different mobile applications and thereby gather the plurality of mobile applications as registered applications. For example, each of N different mobile game Apps may be registered to the promotion platform system 100 for marketing such as its promotion and advertisement, and may share traffic of users of the N game Apps registered to the promotion platform system 100. Each of game Apps registered to the promotion platform system 100 may participate in as an inventory game and concurrently, display its promotion and advertisement through a promotion platform as a target game.

The promotion platform system 100 may provide a compensation or a reward capable of performing marketing such as a promotion and an advertisement with respect to a user of another App to a service provider of an application having a user entry in the promotion platform. Referring to FIG. 2, when a user terminal 1 at 102 enters the promotion platform system 100 through a first application 101, the promotion platform system 100 may display a promotion and an advertisement associated with the first application 101 through the promotion platform. The first application 101 may be advertised to at least one of users of N applications registered to the promotion platform system 100.

Although FIG. 2 illustrates that each of N applications is installed and executed in a single user terminal, it is one of various examples and aspects of the present invention are not limited thereto. Each application may be installed and executed in one or more user terminals according to various configurations. For example, a first application may be installed in user terminals 1 and 3, a second application may be installed in user terminals 1, 2, and N, and an N-th application may be installed in user terminals 2, (N−1), and N.

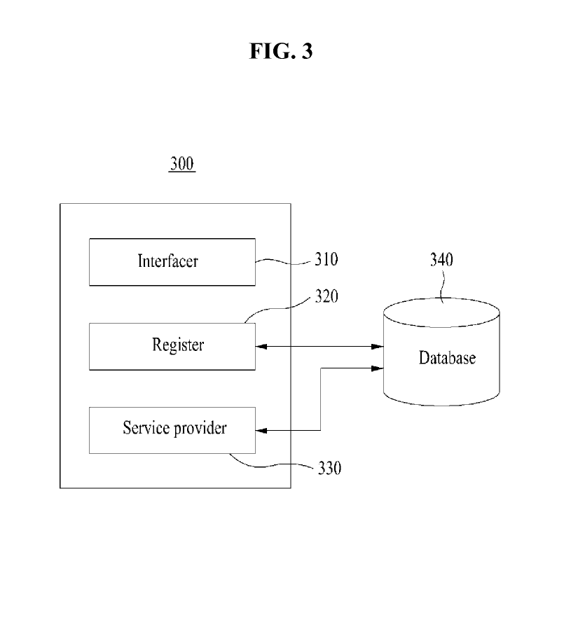

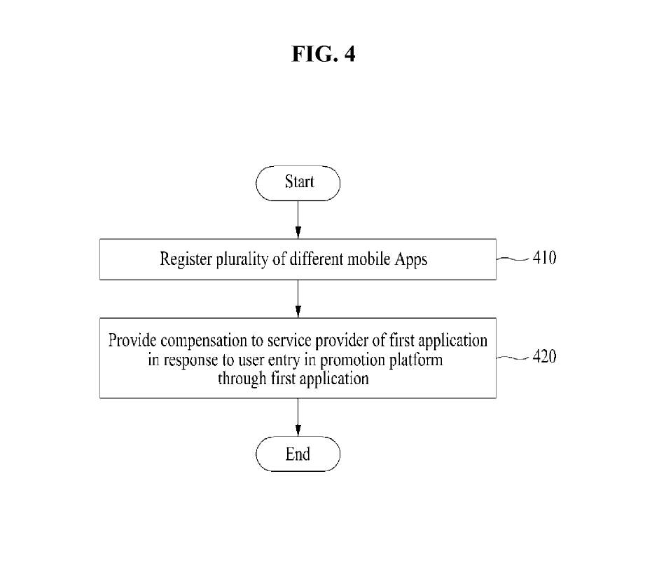

FIG. 3 is a block diagram illustrating a configuration of a promotion platform system according to an exemplary embodiment, and FIG. 4 is a flowchart illustrating a method of providing a promotion platform according to an exemplary embodiment.

Referring to FIG. 3, an interfacer 310, a register 320, a display controller 330, and a database 340 may be configured to perform operations 410 and 420 illustrated in FIG. 4. The promotion platform system 300 refers to a system to provide a mobile platform that performs an App advertisement using a mobile App, and may configure an infrastructure as necessary and may construct an infrastructure utilized for a mobile App advertisement, an App registration, and a compensation scheme. The promotion platform system 300 may include the interfacer 310, the register 320, the display controller 330, and the database 340.

The interfacer 310 may provide a website for providing a service provider interface to a service provider of a mobile App. For example, the interfacer 310 may provide a website for receiving information for a registration to a service provider of a mobile application that is to be registered to the promotion platform system 300.

In operation 410, the register 320 may register a plurality of different mobile Apps through the website provided to service providers of the mobile Apps. For example, a service provider of a mobile App that is to be registered to a promotion platform through the website provided from the interfacer 310 may register an App of the service provider to the promotion platform. A registration process may include a process of inputting registration information of the mobile App participating in as an inventory App and a process of inputting registration information of the mobile App participating in as a target App.

The inventory App may serve to allow a user registered to the inventory App to enter the promotion platform. In the case of participating in as the inventory App, a service provider of the inventory App may input, through the website, compensation information to be provided from the Inventory App to the user when the user enters the promotion platform, and information about an area, e.g., a country, a designated local area, in which a corresponding App is to be displayed. For example, the service provider of the inventory App may input at least one country in which a mobile App, e.g., a game App, is to be released, as a target country. When the game App is to be released in 20 countries, the 20 countries may be input as target countries or only 10 countries among the 20 countries may also be input as target countries. A platform icon may be displayed on the game App of the input target countries. For example, the platform icon may be displayed on an execution screen of the inventory App executed by a mobile terminal located in one of the determined target countries.

A target App may indicate an App to be displayed as an advertisement through a promotion platform to a user having entered the promotion platform through the inventory App. For example, the target App may include an App of a service provider who desires to only advertise the App of the service provider through the promotion platform without registering the App as an inventory App and an App to be advertised through the promotion platform among Apps registered as inventory Apps. In the case of participating in as the target App, a service provider of the target App may input promotion and advertisement content of the target App, a promotion and advertisement period of the target App, compensation information according to a user performing a mission associated with a promotion of the target App, and information about a target area, e.g., a target country, in which the target App is to be advertised. A target App may be associated with an inventory App if the target App registers an associated inventory App in the promotion platform, an inventory App registers the target App as an associated target App in the promotion platform, or the promotion platform associates the target App with one or more inventory Apps based on various conditions and information regarding promotions, target areas, such as target countries, promotion requirements, App categories, and other information described herein.

By using the promotion platform, a single mobile App may be an inventory App and at the same time, a target App. Accordingly, a service provider of the mobile App may input registration information to participate in as the inventory App and registration information to participate in as the target App through an input screen provided from a website. Thus, the mobile App may be a target App based on the registration information to participate in as the target App and may be an inventory App based on the registration information to participate in as the inventory App.

The register 320 may store and manage registration information input through the input screen in the database 340. The database 340 may be included in storage media within the promotion platform system 300, and/or may be connected to the promotion platform system 300 through a network as a server independent from the promotion platform system 300.

When the service provider of the mobile App completes an App registration, the interfacer 310 may provide a promotion interface, e.g., an image associated with a platform icon, to the mobile App. For example, the interfacer 310 may provide an image associated with a brand identity (BI) logo of a platform to the mobile App. In this case, the mobile App may register the platform icon. The BI logo of the platform may be registered as the platform icon alone, and may also be registered as the platform icon through a combination with a display icon being used in the mobile App. For example, in the case of using a game App, the game App may be displayed on a game screen by combining a display icon such as a gift box image and a jewelry image being used in a game with the BI logo of the platform.

In the case of executing the mobile App in a user terminal, the platform icon may be displayed on an initial execution screen or an intermediate execution screen. For example, the platform icon may be displayed at a designated location on a game screen while moving within the game screen not to interrupt a game according to a game progress circumstance. In addition, the platform icon may be static when displayed on a predetermined area such as at an upper end, at a lower end, on the left, and on the right of the game screen. In response to a user executing the game App and clicking on the platform icon, the user may enter the promotion platform.

In operation 420, the display controller 330 may provide a compensation or a reward to a service provider of a mobile App having the user entry in the promotion platform among a plurality of different mobile Apps registered to the promotion platform. For example, when a user playing a game 1 by executing a game App 1 clicks on a platform icon displayed on a screen of the game 1 and enters the promotion platform, the display controller 330 may provide a compensation or a reward capable of displaying a promotion and an advertisement of the game App 1 to users of another App through the promotion platform. For example, the display controller 330 may display an App information screen including a promotion and an advertisement of the game App 1 on a user terminal of a user having entered the promotion platform. The display controller 330 may display the App information screen through an App that has allowed the user terminal to enter the promotion platform.

Here, a compensation associated with the mobile App being executed by the user terminal may be provided to the user of the user terminal having entered the promotion platform. For example, when the game App 1 offers to provide a compensation such as an item associated with the game App 1 or game money for the game App 1 in response to a click on the platform icon, the game App 1 may provide the offered compensation, for example, a game item, game money, and an e-coupon, to the user having entered the promotion platform through a user interface of the game App 1.

The user may verify a promotion and an advertisement of each mobile App displayed through the promotion platform. When one of the displayed promotion and advertisement is selected by the user and the user performs a mission associated with the selected promotion, the selected mobile App may provide a compensation associated with the mobile App to the user. For example, in a case where a promotion of a game App 2 is displayed on the promotion platform and promotion content of the game App 2 relates to an offer to provide game money for member join, when the user having entered the promotion platform through the game App 1 joins the game App 2, the game App 2 may provide the offered game money to the user.

A mission associated with a promotion of a mobile App may vary. For example, a mission, such as installing a program of the corresponding App, viewing a moving picture, a member join, a survey, and a follow, may be preselected by an App provider or the promotion platform. A compensation or a reward according to a mission completion may include game money, a game item, and an e-coupon in the mission completed App.

FIG. 4 illustrates an example in which the game App 1 having the user entry in the promotion platform provides a compensation or a reward to the user and the game App 2 provides a compensation or a reward according to the user having completed a mission of the game App 2. Further, the promotion platform may also provide a compensation to the user. For example, the display controller 330 may provide a compensation, for example, game money of the game App 1, offered by the game App 1 to a user having entered the promotion platform by controlling the game App 1. Similarly, the display controller 330 may provide a compensation, for example, game money of the game App 2, offered by the game App 2 to a user having completed a mission of the game App 2 by controlling the game App 2.

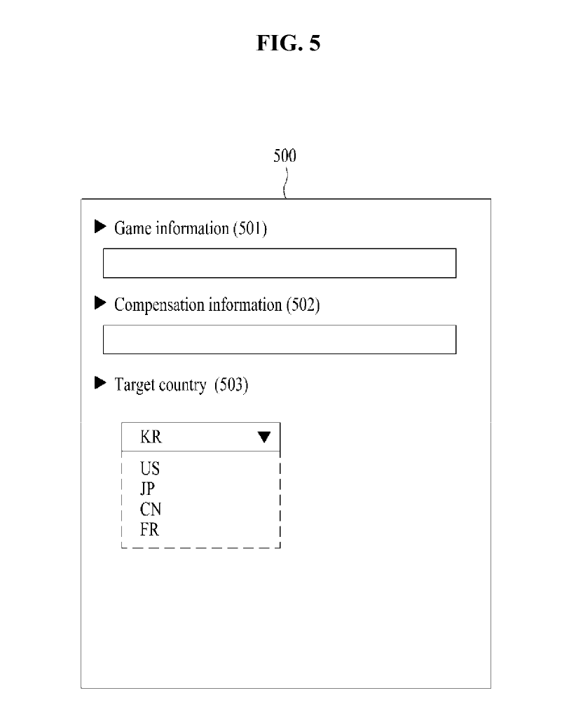

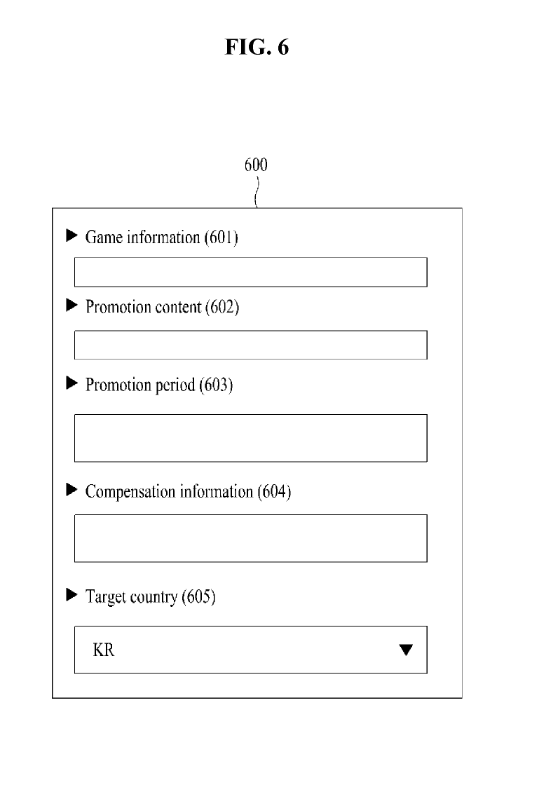

FIG. 5 illustrates a registration screen on which a mobile App participates in a promotion platform as an inventory App according to an exemplary embodiment, and FIG. 6 illustrates a registration screen on which a mobile App participates in a promotion platform as a target App according to an exemplary embodiment.

Referring to FIG. 5, a service provider of a mobile App may input requested information when participating in as an inventory App through an interface, e.g., a website format, provided from the promotion platform system 300.

For example, when registering a game App to the promotion platform system 300, a service provider of the game App may input information requested for the game App to operate as an inventory App through an inventory App registration screen 500. For example, the service provider of the game App may input game information 501 such as a game name and a game type, compensation information 502 to be provided to a user in response to a user entry in a promotion platform, and target country information 503. The target country information 503 may indicate a country in which users of the game App are to be provided with a platform icon when executing the game App among countries connected to the game App. For example, any one country may be input as a default, and a plurality of countries, for example, 20 countries may be input. When a service provider of the game App inputs information requested to participate in as the inventory App and selects a save button, the input information may be stored in the database 340.

When the information requested to participate in as the inventory App is input, the service provider of the mobile App may input information requested to participate in as a target App through a website provided from the promotion platform system 300 as illustrated in FIG. 6.

For example, when registering a game App to the promotion platform system 300, a terminal of a service provider of the game App may transmit game information 601, promotion and advertisement information, compensation information 604, and target country information 605 to the promotion platform system 300. The promotion information may include promotion content 602 and a promotion period 603. For example, the service provider of the game App may input the promotion content 602 such as installing a program of the game App, a member join, and a follow. Similarly, the advertisement information may also include advertisement content introducing the game App and an advertisement period. The compensation information 604 may include compensation content, e.g., game money and a game item to be provided to the user who completes a mission associated with the input promotion content 602, e.g., installing the program of the game App.

The target country may indicate a county in which the target App is to be advertised. For example, the service provider of the target App may desire to advertise an App of the service provider in a country in which many users are using a mobile App, to increase an advertising effect.

Here, when a corresponding App is registered as an inventory App and is registered as a target App of another inventory App, the target App may be advertised free of charge through the promotion platform as a compensation for the user entry in the promotion platform through its service as an inventory App. For example, when a single user enters the promotion platform, the display controller 330 may display the target App to a single user of another App. Accordingly, when the service provider of the target App inputs a target country, and in this instance, when the service provider registers the corresponding App as the target App instead of registering the App as an inventory App, which is similar to a case in which the corresponding App is registered as both the inventory App and the target App, the display controller 330 may display the target App based on the target country input through a target App registration screen 600.

Referring to FIG. 5 and FIG. 6, when a mobile App is registered to the promotion platform system 300 through the inventory App registration screen 500 and/or the target App registration screen 600, the promotion platform system 300 may provide an image associated with a BI logo of the promotion platform to the registered mobile App. To allow a user to enter the promotion platform and to display a promotion and an advertisement, the service provider may download an analytics software development kit (SDK) and may install the downloaded analytics SDK in the registered mobile App. The mobile App in which the analytics SDK is installed may be distributed to users through Appstore and a market.

In this instance, before the mobile App is distributed to Appstore, a test for verifying whether a promotion is accurately operating in the mobile App may be performed. For example, a test terminal may download the mobile App and may test the mobile App regarding whether the promotion is accurately displayed. Once the test is completed, the mobile App may be distributed.

An exemplary embodiment in which the mobile App participate in as both the inventory App and the target App is described above with reference to FIG. 5 and FIG. 6. Further, the mobile App may also participate in the promotion platform as one of the inventory App and the target App.

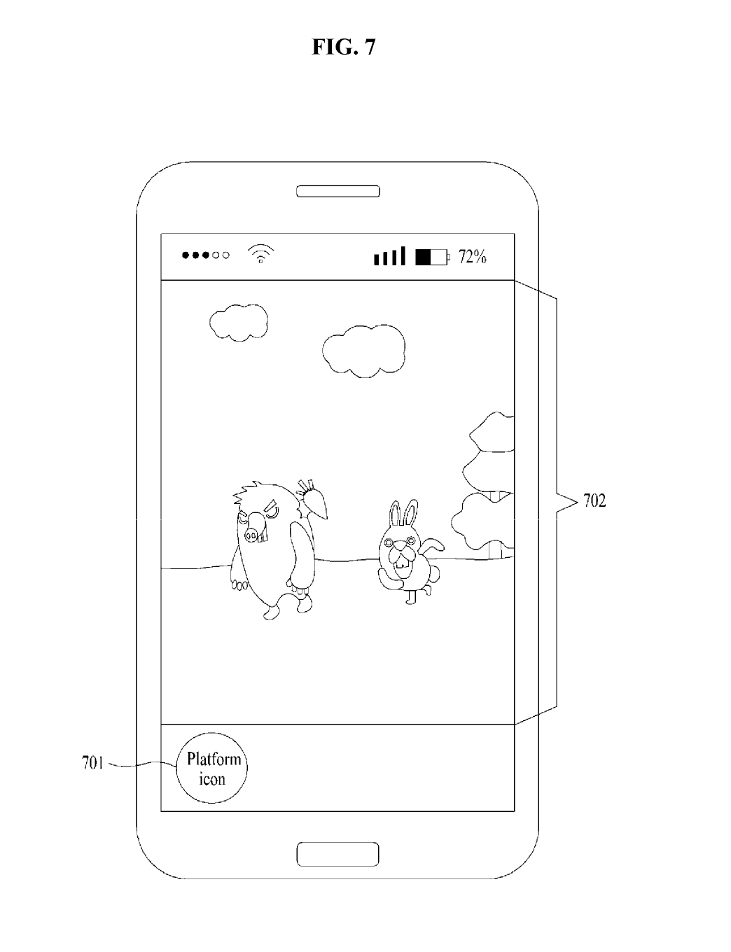

FIG. 7 illustrates a screen on which a mobile App registered to a promotion platform provides a platform icon according to an exemplary embodiment.

In FIG. 7, it is assumed that a game App is registered to a promotion platform. In addition to the game App, various types of Apps such as a map and a webtoon may be registered the promotion platform.

If the game App is registered to the promotion platform and an analytics SDK is installed in the game App, a platform icon 701 for entry in the promotion platform may be displayed on a user terminal having executed the game App. The platform icon 701 may include an image associated with a BI logo of the promotion platform and may be displayed at an upper end, at a lower end, on the left, or on the right of a game screen in a feed form. Here, the platform icon 701 may be displayed on an area not to interrupt the user from playing a game.

For example, the platform icon 701 may be displayed in a translucent form at a lower end of the game screen, and may also be displayed in a popup window while executing a game and then loading the game. In addition, the platform icon 701 may be displayed in a popup window form during a loading time and may be displayed at a designated location on a portion of the game screen or while changing a display location not to interrupt the user playing the game.

If the user selects the platform icon 701, the user may enter the promotion platform through the game App. When the user enters the promotion platform through the game App, the display controller 330 may count the number of users having entered the promotion platform through the corresponding App and may display a promotion and an advertisement of the corresponding App based on a count result. For example, when 10 users have entered the promotion platform through the game App, the display controller 330 may display the promotion and the advertisement of the game App to ten users having entered the promotion platform through another App.

According to an exemplary embodiment, when the user does not want to display the platform icon 701 and selects a stop button, the platform icon 701 may not be displayed on the game screen.

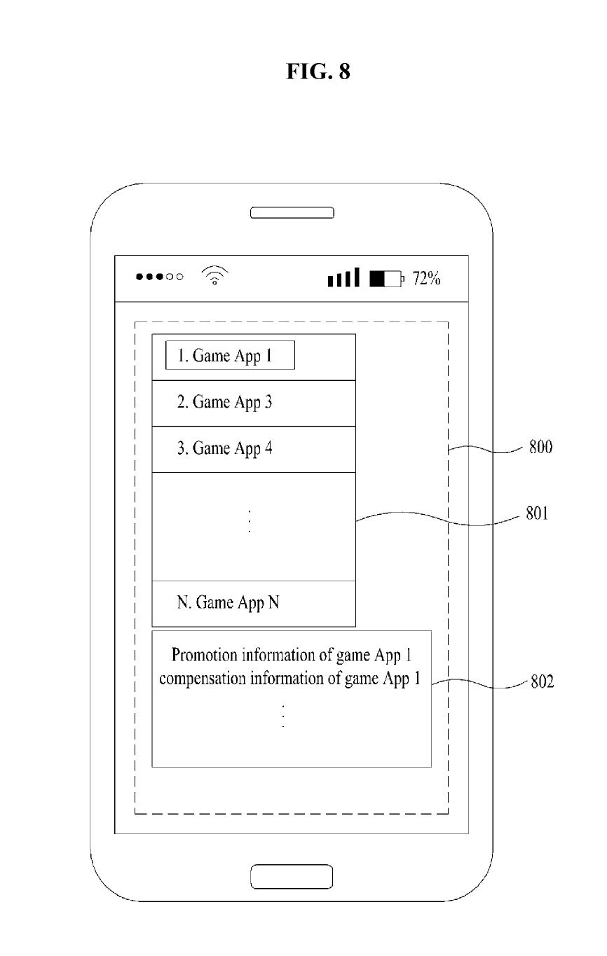

FIG. 8 illustrates an App information screen displayed to a user in response to a user entry in a promotion platform through an App in execution according to an exemplary embodiment. In FIG. 8, a description will be made based on an example of an App information screen displayed to a user in response to the user having entered a promotion platform through a game App 2. Also, in FIG. 8, a description will be made based on an example in which the game App 2 is deleted from an App information list in response to the user entry in the promotion platform through the game App 2. However, it is one of various examples and thus, a promotion and an advertisement of the game App 2 may also be displayed on an App information list so that the user having entered the promotion platform through the game App 2 may verify promotion information of the game App 2.

When a game App is registered to the promotion platform, the display controller 330 may generate an App information list 801 to display promotions and advertisements of target Apps based on registration information of registered game Apps, for example, a game App 1 through a game App N registered as target Apps. When a user enters the promotion platform through the game App 2, an App information screen 800 may be displayed to the user, for example, on a user terminal of the user. The App information screen 800 may include a screen for displaying the App information list 801 including a plurality of registered target Apps, e.g., Game App 1, Game App 3, . . . , and Game App N, and a screen for displaying promotion information and compensation information 802 of a target App selected by the user from among the target Apps displayed on the App information list 801. When relatively many target Apps are included in the App information list 801, a scroll may be created at the App information list 801 to navigate through the target Apps in the App information list 801. The target Apps may not be limited to game Apps or Apps registered by the same service provider of the inventory App. For example, a cartoon App or other associated App may be displayed as a target App.

Here, when the user having entered the promotion platform through the game App 2 selects the game App 1 on the App information list 801, details associated with a promotion and an advertisement, such as promotion information and compensation information 802 associated with the game App 1 may be displayed at a designated portion, e.g., a lower end, of the App information screen 800. For example, content indicating “We will pay game money of the game App 1 if you install a program of the game App 1 by MM DD, YYYY” may be displayed below the App information list 801. In addition, the App information list 801 may be displayed on the entire screen, and promotion information and compensation information 802 of the selected target App may be displayed as a popup window. Further, such information may be displayed using a variety of methods.

Whenever the App information list 801 including the game App 1 is displayed for a user having entered the promotion platform, the display controller 330 may count the number of times (hereinafter, display counts) the App information list 801 is displayed. Here, when the number of users having entered the promotion platform reaches the display counts, the display controller 330 may delete the promotion and the advertisement of the game App 1 from the App information list 801. More specifically, the promotion and the advertisement of the game App 1 may not be displayed through the promotion platform after reaching the target number of exposure to uses of one or more inventory Apps. When the service provider of the game App 1 readjusts the display counts, the display controller 330 may resume the promotion and the advertisement of the game App 1.

For example, when a user enters the promotion platform after the service provider of the game App 1 increases the display counts or after the game App 1 satisfies the display counts as both the inventory App and the target App, the display controller 330 may resume the promotion and the advertisement of the game App 1 through the promotion platform.

As described above, the display controller 330 may monitor the game App 1 to display the promotion and the advertisement of the game App 1 to a user of another registered game App. More specifically, the display controller 330 may periodically monitor the number of users having entered the promotion platform through the game App 1 and the number of times the promotion and the advertisement of the game App 1 are displayed.

To advertise registered Apps to many users, the display controller 330 may not provide a service provider of a corresponding App with a compensation according to a duplicate entry of the same user in the promotion platform within a predetermined period, e.g., one day, one week, one month, three months, six months, and the like. For example, for a first entry of a user 1 in a promotion platform during a day through the game App 1, the display controller 330 may increase the number of users of the game App 1 and may not count the user 1 with respect to a second or more entry of the user 1 during the day. When the same user having entered the promotion platform on the previous day enters again the promotion platform on the following day or when another user of the game App 1 enters the promotion platform, the display controller 330 may count the corresponding user and increases the number of users of the game App 1 entering the promotion platform.

Referring to FIG. 8, if a user having entered the promotion platform through the game App 2 selects the game App 1 by e.g., a long touch or double touch of the game App 1 on the App information list 801, the display controller 330 may display a promotion screen to the user to be capable of performing a promotion associated with the game App 1. For example, the display controller 330 may provide the user with a screen for downloading a screen of the game App 1 and a moving picture associated with the game App 1. Further, the display controller 330 may display conditions to receive promotional items associated with the game App 1. When a user having entered the promotion platform through the game App 2 performs a task of a promotion, such as installing a program of the game App 1, the game App 1 may provide the user with a compensation, for example, game money of the game App 1, offered and displayed on the screen. Further, the game App 2 may also provide a compensation or a reward when the user performs a task of a promotion or achieves a condition of a promotion.

An example of displaying only target Apps on the App information list 801 on the App information screen 800 is described above with reference to FIG. 8. However, it is one of various examples and thus, contents associated with the target Apps may also be displayed together with the target Apps. For example, when a target App is a game App, game related contents such as a blog and a moving picture associated with a game promise or a promotional offer may be displayed together with target game Apps.

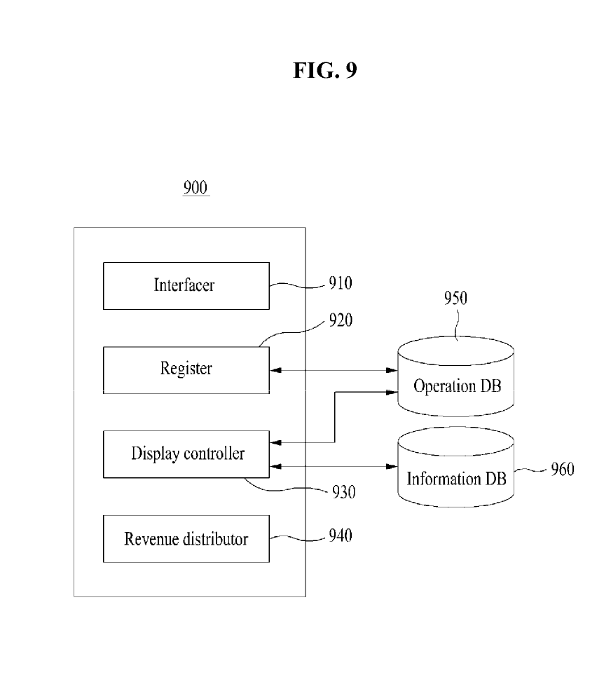

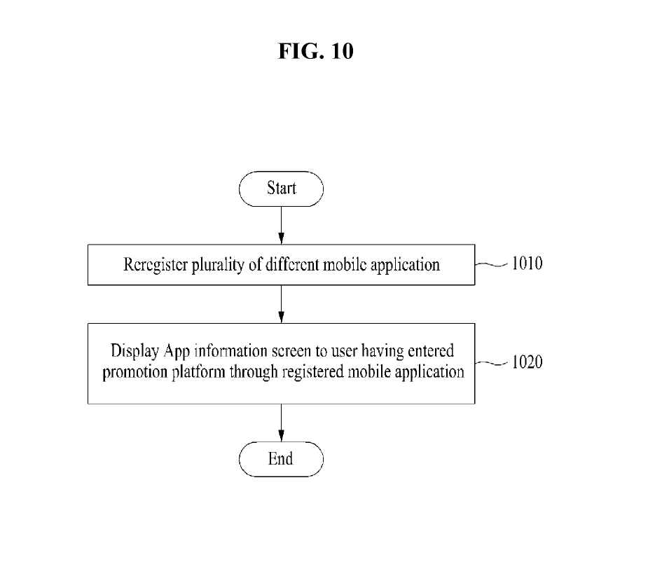

FIG. 9 is a block diagram illustrating a configuration of a promotion platform system according to an exemplary embodiment, and FIG. 10 is a flowchart illustrating a method of displaying information data of mobile Apps registered to a promotion platform according to an exemplary embodiment.

Referring to FIG. 9, the promotion platform system 900 may include an interfacer 910, a register 920, a display controller 930, a revenue distributor 940, an operation database (DB) 950, and an information DB 960. Each of the constituent elements, for example, the interfacer 910, the register 920, the display controller 930, the revenue distributor 940, the operation database 950, and the information database 960, of the promotion platform system 900 may be configured to perform operations 1010 and 1020 of FIG. 10.

Further, the promotion platform system 900 may analyze mobile data generated from a user having entered the promotion platform system 900 through a mobile App by constructing a hadoop-based system and may provide user customized retargeting information, for example, a retargeting advertisement.

One or more operations of registering a mobile application in FIG. 9 similar to those described with reference to FIG. 3 and FIG. 4 may be omitted for conciseness. Accordingly, other operations of registering a mobile application will be described with reference to FIG. 9 and FIG. 10.

In operation 1010, the register 920 may register a plurality of different mobile Apps through the interfacer 910. To this end, the interfacer 910 may provide a website for providing a service provider interface to a service provider of a mobile App, and the service provider of the mobile App may register a variety of mobile Apps, such as a game App and a shopping App, to a promotion platform through the provided website. Registered information may be stored in the operation database 950 and utilized to manage the registered mobile Apps.

In operation 1020, the display controller 930 may display an App information screen to a user having entered the promotion platform through the mobile application registered to the promotion platform. The App information screen may include areas for displaying promotion information ongoing in the registered mobile application, advertisement information, content information, and external information, e.g., external information such as an e-commerce advertisement.

The display controller 930 may display information data on the App information screen as a compensation for the mobile application that has allowed the user to enter the promotion platform among the registered mobile applications.

For example, when a user of a game App 1 selects a platform icon and enters a promotion platform, the display controller 930 may add a promotion and an advertisement of the game App 1 to an App information list and may display the added App information list on the App information screen. Revenues may occur in response to displaying external information on the App information screen. The revenue distributor 940 may distribute the revenues to service providers of the registered mobile applications. Information data such as promotion information, advertisement information, content information, and external information may be stored in the information database 960.

Here, the display controller 930 may display the information App screen by applying a weight to each mobile App based on the number of users having been allowed to enter the promotion platform for each registered mobile App. For example, the display controller 930 may provide relatively high display counts and a relatively high display priority to an App having allowed relatively many users to enter the platform or an App having made efforts to allow a relatively large number of users to enter the platform.

According to an exemplary embodiment, when game Apps 1, 2, and 3 registered to the platform have allowed three users, two users, and one user to enter the platform, respectively, the display controller 930 may generate an App information list to display the game App 1 three times, the game App 2 twice, and the game App 3 once on the App information screen, or to assign a relatively high display priority in order of the game App 1, the game App 2, and the game App 3. For example, the game App 1 may be displayed at an upper end of the App information screen compared to the game App 2.

According to an exemplary embodiment, when the game App 1 provides a compensation of game money corresponding to 5 monetary units of game App 1, the game App 2 provides a compensation of game money corresponding to 3 monetary units of game App 2, and the game App 3 provides a compensation of game money corresponding to 1 monetary unit of game App 3 to allow a user to enter a platform, the display controller 930 may verify that the amount of compensations and/or efforts to induce users to enter the platform are made in order of the game App 1, the game App 2, and the game App 3 based on registration information. The display controller 930 may assign relatively high display counts in order of the game App 1, the game App 2, and the game App 3, and may also assign a relatively high display priority in order of the game App 1, the game App 2, and the game App 3.

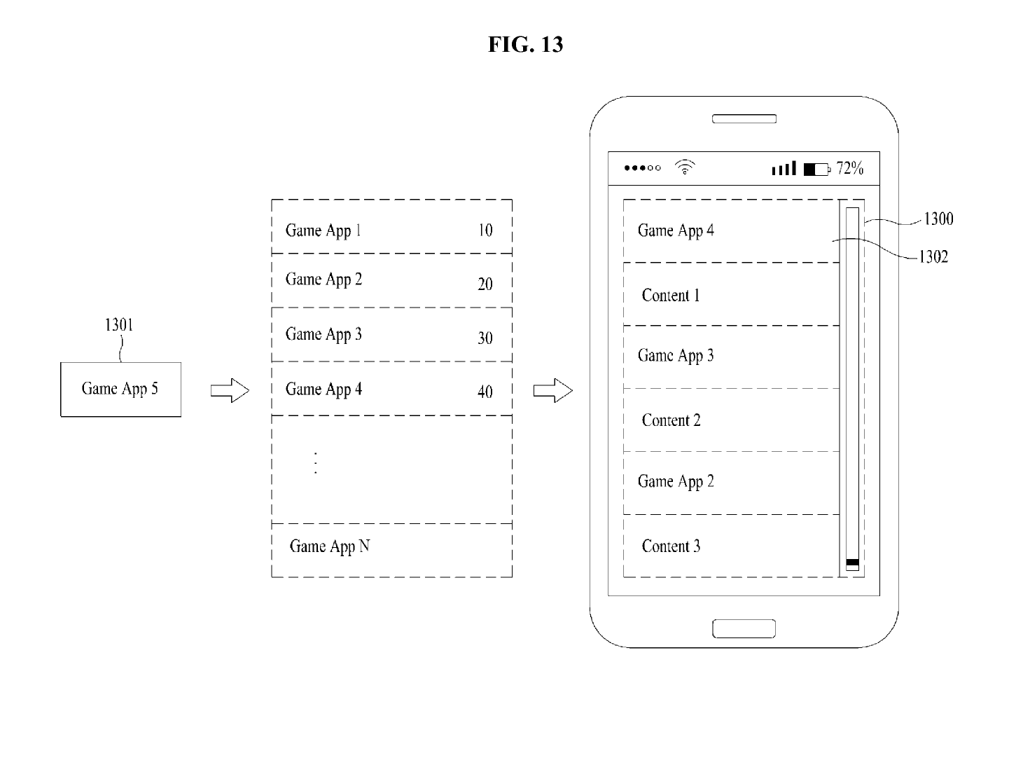

Further, the display controller 930 may determine a display based on a popularity of target game Apps, which will be described with reference to FIG. 13.

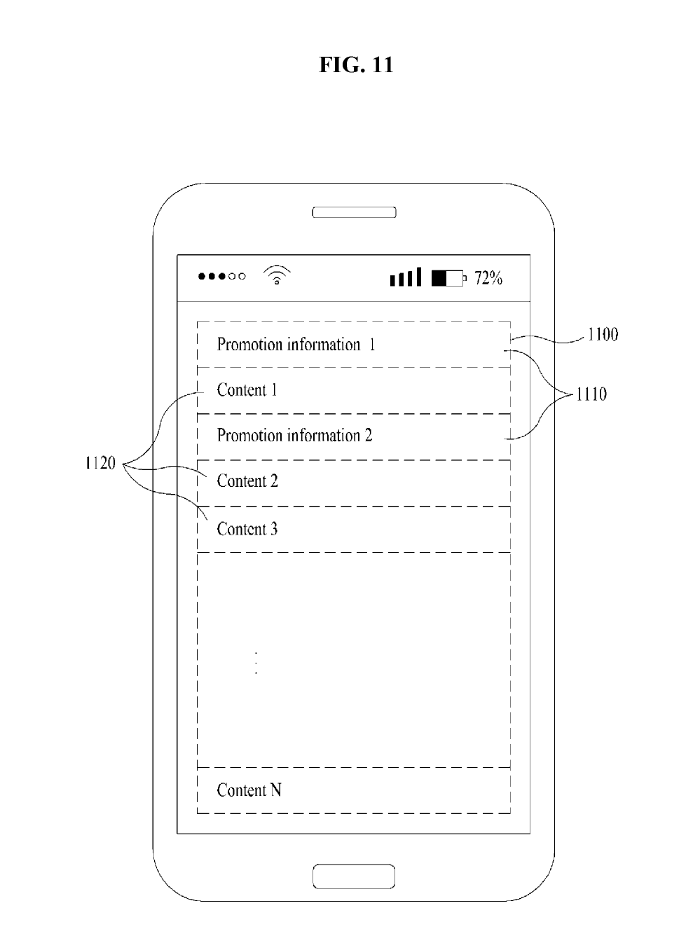

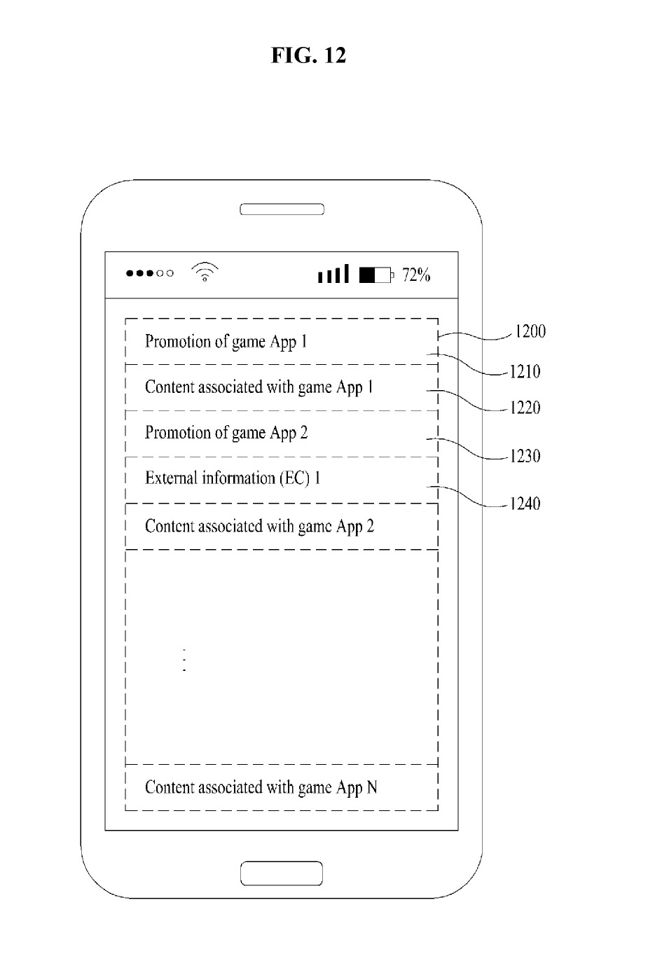

FIG. 11 and FIG. 12 illustrate an App information screen for displaying target Apps and contents together according to an exemplary embodiment.

FIG. 11 illustrates an App information screen for displaying information data, e.g., a promotion and an advertisement, of a mobile App registered to a promotion platform and content associated with the mobile App according to an exemplary embodiment, and FIG. 12 illustrates an App information screen for displaying information data of a registered mobile App, content, and external information according to an exemplary embodiment. Referring to FIG. 9, FIG. 11, and FIG. 12, a promotion and an advertisement of a registered mobile App, content information, and external information may be stored in advance in the information database 960. Here, the external information refers to paid information for displaying information associated with a mobile application unregistered to the promotion platform. For example, the external information may correspond to a paid advertisement.

When a user selects a platform icon and enters the promotion platform, the display controller 930 may display an App information screen 1100 to the user. Referring to FIG. 11, the App information screen 1100 may include a promotion area 1110 for displaying a promotion and an advertisement of a mobile App having allowed the user to enter the promotion platform and a content area 1120 for displaying contents. The content area 1120 may include an area for registering only contents associated with target Apps as illustrated in FIG. 11, and may include an area for displaying external information 1240 in addition to contents 1220 associated with target Apps as illustrated in FIG. 12.

The display controller 930 may sequentially display the promotion and the advertisement of one or more mobile Apps and then may also continuously display related content at a lower end of or below the promotion and the advertisement, and may also alternately display a promotion and an advertisement of each mobile App and content. The promotion area 1110 may be positioned at an upper end of the App information screen 1100 compared to the content area 1120 so that the promotion area 1110 is relatively quickly recognized by a user.

According to an exemplary embodiment, if game Apps 1, 2, and 3 have induced relatively mores users to enter the promotion platform in order of the game App 1, the game App 2, and the game App 3 among mobile applications registered to the promotion platform, the display controller 930 may display a promotion and an advertisement of the game App 1 on the top of the App information screen 1100 and may display content associated with the game App 1 on a second column (or row) that is a subsequent column (or row) of the game App 1. The display controller 930 may display a promotion and an advertisement of the game App 2 on a third column (or row) and may display content associated with the game App 2 on a fourth column (or row). The display controller 930 may sequentially display a promotion and an advertisement of the game App 3 on a fifth column (or row), content associated with the game App 3 on a sixth column (or row), and content associated with external information on a seventh column (or row). Contents associated with the game App 1, the game App 2, and the game App 3 may include moving pictures, out-links, hyper-links, and blogs associated with the game App 1, the game App 2, and the game App 3, respectively.

According to an exemplary embodiment, the display controller 930 may display the game Apps 1, 2, and 3 on the first column (or row), the second column (or row), and the third column (or row) of the App information screen 1100, respectively, and may display contents associated with the game Apps 1, 2, and 3 on the fourth column (or row), the fifth column (or row), and the sixth column (or row) of the App information screen 1100, respectively. In addition, the display controller 930 may mix and display a promotion and an advertisement of a game App and contents associated therewith using a variety of methods, such as displaying at least two related contents after displaying a game App.

Here, content associated with a mobile App displayed on the promotion area 1110 and affiliated content of different business may also be displayed on the content area 1120. The affiliated content of different business refers to an external advertisement unregistered to the promotion platform and may indicate content associated with an external advertisement such as an EC advertisement, e.g., a shopping App, a game App similar to a registered game App, and a music App. Referring to FIG. 12, the display controller 930 may mix and display a promotion and an advertisement of a mobile App having induced or allowed a user to enter platform, content, and external information on an App information screen 1200.

According to an exemplary embodiment, the display controller 930 may display a promotion and an advertisement 1210 of the game App 1 having a top display priority among registered target game Apps on a top of the App information screen 1200 and then display content 1220 associated with the game App 1. The display controller 930 may sequentially display a promotion and an advertisement 1210 of the game App 2 and external information 1230. In FIG. 12, external information, which is not associated with the game App 1, for example, the same type of external game may be displayed after game App 1 is displayed. The same type of external game may not be a target App of the game App 1 but it may have a rating above a threshold among the registered game Apps registered in the promotion platform and similar features of the game App 1. As described above, the promotion platform system 900 is to display an advertisement free of charge as a compensation for registered Apps that allow a user to enter a promotion platform. Thus, the display controller 930 may preferentially dispose target game Apps to be displayed on an upper portion of the App information screen 1200 and then may display related contents or external information among the target game Apps.

FIG. 13 illustrates a process of determining display priorities of mobile applications to be displayed on an App information screen according to an exemplary embodiment

A description will be made based on an example in which a user has entered a promotion platform through a game App 5 1301 registered to the promotion platform with reference to FIG. 13.

The display controller 930 may determine display priorities of target Apps based on click information of each of a target App and an inventory App registered to the promotion platform. The display controller 930 may determine a display priority of a target App of a corresponding day, based on a click rate having occurred through the inventory App during the previous day and a click through ratio (CTR) between the inventory App and the target App. The display controller 930 may determine that if a target App induces more clicks, the target App is more popular among users. Accordingly, the display controller 930 may determine display priorities of target Apps in a descending order of popularity and may display the target Apps on the App information screen 1200 based on the determined display priorities.

Referring to FIG. 13, the game App 5 1301 may be an inventory App and game Apps 1, 2, 3, and 4 may be target Apps associated with the game App 5 1301. Hereinafter, a description will be made based on an example in which 1000 users entered the promotion platform through the game App 5 1301 during the previous day and 200 clicks have occurred from the users. If users having entered the promotion platform through the game App 5 1301 have clicked the game App 1 displayed on an App information screen 1300 a total of 10 times, the display controller 930 may determine a CTR of the game App 1 as 0.05 by dividing the number of clicks “10” on the game App 1 by a total number of clicks “200” of the game App 5. In the same manner, if the users having entered the promotion platform through the game App 5 1301 have clicked the game App 2, the game App 3, and the game App 4, 20, 30, and 40 times, respectively, the display controller 930 may determine a CTR of the game App 2 as 0.1, a CTR of the game App 3 as 0.15, and a CTR of the game App 4 as 0.2.

The display controller 930 may calculate a click rate for each target App with respect to an inventory App, e.g., the game App 5 1301. For example, the display controller 930 may calculate a click rate of the game App 1 of the previous day as 0.01 by dividing the number of clicks “10” occurred for the game App 1 by the number of users “1000” who entered the promotion platform through the game App 5 1301. In the same manner, the display controller 930 may calculate a click rate of the game App 2 as 0.02, may calculate a click rate of the game App 3 as 0.03, and may calculate a click rate of the game App 4 as 0.04. The display controller 930 may determine a weight for each target App by adding up a CTR and a click rate for each target App. For example, a weight of the game App 1 may be calculated as 0.06, a weight of the game App 2 may be calculated as 0.12, a weight of the game App 3 may be calculated as 0.18, and a weight of the game App 4 may be calculated as 0.24. The weight is high in order of the game App 4, the game App 3, the game App 2, and the game App 1 and thus, the display controller 930 may generate an App information list so that the game App 4 is displayed on a top 1302 and the game Apps 3, 2, and 1 are displayed below the game App 4, and may display the App information list on the App information screen 1300 as shown in FIG. 13.

In this instance, the display controller 930 may generate the App information list to locate content associated with each game App, or to locate external information associated with each game App among the game Apps 4, 3, 2, and 1. The display controller 930 may generate the App information list by determining a display priority of content and external information.

Referring to FIG. 13, a promotion area and a content area among areas of the App information screen 1300 may be determined differently so that mutual locations are changed, and the promotion area may be designated as the first row and the third row among the display areas and the content area may be designated as the second row and the fourth row among the display areas (see e.g., the App information screen 1300 of FIG. 13). If the promotion area is designated as described above, the display controller 930 may generate the App information list so that the game App 4 and the game App 3 having relatively high display priorities may be displayed on the first and third rows among display areas of the App information screen 1300. The display controller 930 may determine display priorities of content and external information to be displayed after the second and the fourth rows.

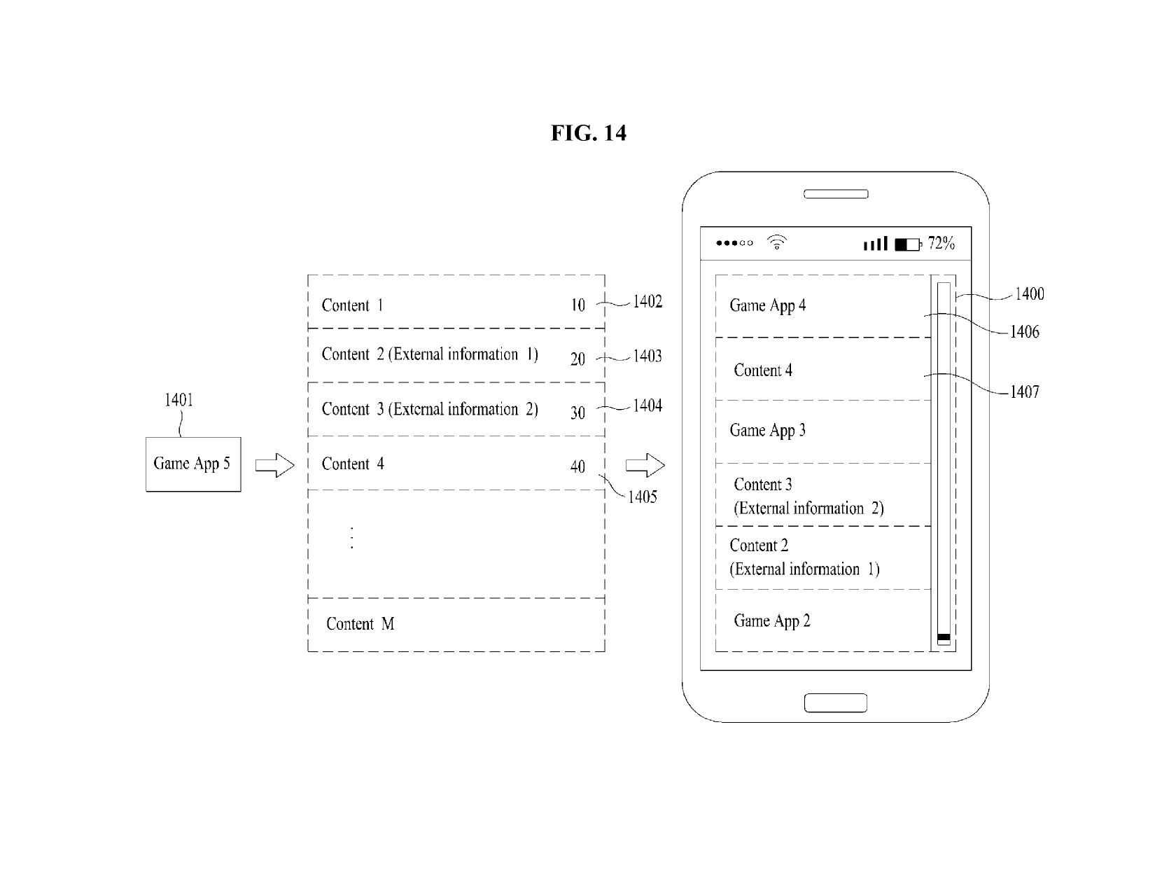

FIG. 14 illustrates a process of determining display priorities of external information and contents associated with mobile applications to be displayed on an App information screen according to an exemplary embodiment.

A description will be made based on an example in which a user has entered a promotion platform through a game App 5 1401 with reference to FIG. 9 and FIG. 14. The display controller 930 may extract contents associated with the game App 5 1401 having a relatively high priority among contents associated with mobile Apps stored in the information database 960. The display controller 930 may extract information associated with the game App 5 1401 and the user (who has entered the promotion platform through the game App 5 1401) from external information stored in the information database 960. The display controller 930 may determine display priorities of extracted contents and external information. Here, the display controller 930 may extract retargeting information based on a tracking log and a user reaction to external information and contents displayed on an App information screen 1400. For example, the user reaction may include a presence or absence of a click on an advertisement or other displayed contents or promotions, a stay time at a corresponding website, a product purchase history at the corresponding website, and a product search history.

According to an exemplary embodiment, if a user having entered the promotion platform through the game App 5 1401 is a new user, the display controller 930 may extract related external information from external information stored in the information database 960, based on a site previously visited by the new user before entering the promotion platform based on a tracking log of the new user, and a history at the visited site, for example, an article and a webtoon read at the site, purchase of a sound source, shopping history, a game played at the site, and the like. For example, if the user executed and played a game by executing the game App 5 1401 prior to entering a promotion platform and downloaded a sound, a song, or other digital contents from a download source prior to executing the game App 5 1401, the display controller 930 may extract contents associated with the game App 5 1401, an external hyperlink or an out-link about the downloaded sound or the like, and external information associated with the downloaded sound or the like from the information database 960.

According to an exemplary embodiment, if a user having entered the promotion platform through the game App 5 1401 is a revisiting user, the display controller 930 may extract external information and content associated with the revisiting user from the information database 960 based on a reaction and a tracking log of the revisiting user. The display controller 930 may extract contents associated with the game App 5 1401 from the information database 960. For example, the display controller 930 may extract contents having a relatively high similarity to content displayed at a previous visit and external information having a relatively high similarity to external information displayed at the previous visit, based on the similarity. For example, the similarity and/or correlation between contents or external information may be analyzed based on a tag or metadata of the contents or the external information to be compared.

Here, the display controller 930 may extract content and external information from the information database 960 by further considering a level of user interest in addition to the similarity. For example, the display controller 930 may extract, from contents and external information displayed at the previous visit, a predetermined number of or percentage of external information and contents having a relatively high similarity with content and external information clicked and thereby selected by the user. The display controller 930 may determine display priorities of the extracted contents and external information. In this instance, data such as a similarity between contents, a similarity between a plurality of external information, and a level of user interest may be calculated based on data analyzed by a hadoop system constructed in the promotion platform system 900.

Here, the display controller 930 may determine display priorities of the extracted contents and external information, based on the number of users having entered the promotion platform (e.g., the promotion platform system 900) through an inventory App registered to the promotion platform, the number of clicks on content or external information, and an up-to-date aspect. For example, the display controller 930 may calculate a CTR of each of content and external information by dividing the number of clicks on each content or external information through the game App 5 1401 during the previous day by the number of users “1000” having entered the promotion platform through the game App 5 1401 during the previous day. For example, referring to FIG. 14, a CTR of content 1 at 1402 may be calculated as 0.01(10/1000), a CTR of content 2 at 1403 may be calculated as 0.02(20/1000), a CTR of content 3 at 1404 may be calculated as 0.03(30/1000), and a CTR of content 4 at 1405 may be calculated as 0.04(40/1000).

In this example, when the content 1 at 1402 is a moving picture associated with a game App 4, the content 4 at 1405 is a blog associated with the game App 4, and each of the content 2 at 1403 and the content 3 at 1404 is external information, a weight for each content may be calculated by adding up a CTR of each content and an uploaded up-to-date aspect of each of the content 1 at 1402, the content 2 at 1403, the content 3 at 1404, and the content 4 at 1405. When the content 4 at 1405 is most recently uploaded and the recent upload is performed in order of the content 3 at 1404, the content 2 at 1403, and the content 1 at 1402, a relatively high weight may be calculated in order of the content 4 at 1405, the content 3 at 1404, the content 2 at 1403, and the content 1 at 1402. The display controller 930 may generate an App information list so that contents, promotion, etc. may be displayed on a relatively upper portion of a content area in order of the content 4 at 1405, the content 3 at 1404, the content 2 at 1403, and the content 1 at 1402.

For example, referring to FIG. 14, the game App 4 having a top display priority among target Apps may be displayed on a top area 1406 of a promotion area (e.g., the first row of the App information list) and content 4 having a top display priority among contents 1, 2, 3, and 4 may be displayed on a top area 1407 of a content area (e.g., the second row of the App information list). The contents 3 and 4 having second and third display priorities may be sequentially displayed.

In this example, the contents 3 and 4 are paid retargeting information and revenues may occur in response to a click of the user having entered the platform through the game App 5 at 1401 on at least one of the contents 3 and 4. The game distributor 940 may distribute the revenues having occurred through the retargeting information to a service provider of an inventory App.

For example, the revenue distributor 940 may distribute a relatively large amount of revenues to be in proportion to an entry ratio according to an increase in the number of users that have been allowed to enter the promotion platform. The number of users secured for each inventory App may differ. A popular large App may secure a relatively large number of users. A less popular or new App may secure a relatively small number of users. However, irrespective of the number of users, the revenue distributor 940 may distribute a relatively large amount of revenues to an inventory App that provides a large compensation in order to allow a user to enter the promotion platform. In addition, the revenue distributor 940 may also distribute revenues by considering both the number of users having been allowed to enter the promotion platform and a compensation amount paid for the user entry.

Here, the distribution of revenues may include a distribution of financial revenues paid from a service provider, e.g., an advertiser of external information and may also include additionally providing the number of displays corresponding to the financial revenues to a corresponding mobile App. Further, the revenue distributor 940 may also distribute revenues with respect to an inventory App by providing a relatively high display priority on an App information screen. Service providers of inventory Apps may input a method of receiving revenue distribution when inputting registration information, which may be referred to as a revenue distribution identifier. For example, the register 920 may receive information associated with the revenue distribution and may also change a revenue distribution style after registration on the inventory App registration screen of FIG. 5.

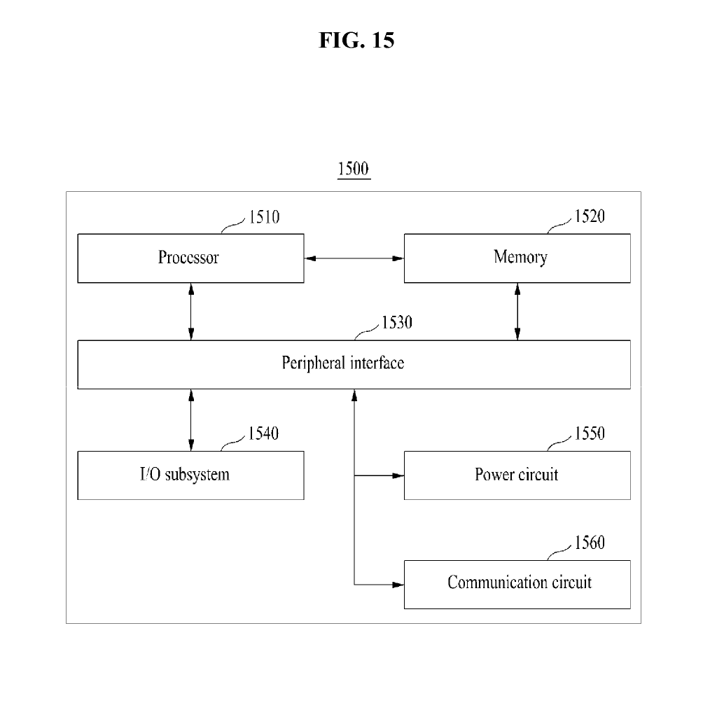

FIG. 15 is a block diagram illustrating a configuration of a computer system according to an exemplary embodiment.

Referring to FIG. 15, the computer system 1500 may include at least one processor 1510, a memory 1520, a peripheral interface 1530, an input/output (I/O) subsystem 1540, a power circuit 1550, and a communication circuit 1560. Here, the computer system 1500 may correspond to a user terminal, a service provider terminal, or a promotion platform system.

The memory 1520 may include, for example, a high-speed random access memory (HSRAM), a magnetic disk, a static random access memory (SRAM), a dynamic RAM (DRAM), read only memory (ROM), a flash memory, and a non-volatile memory. The memory 1520 may include a software module, an instruction set, or a variety of data associated with an operation of the computer system 1500. Here, an access from another component such as the processor 1510 and the peripheral interface 1530 to the memory 1520 may be controlled by the processor 1510.

The peripheral interface 1530 may couple an input device and/or output device of the computer system 1500 with the processor 1510 and the memory 1520. The processor 1510 may perform a variety of functions for the computer system 1500 and process data by executing the software module or the instruction set stored in the memory 1520.

The I/O subsystem 1540 may couple various I/O peripheral devices with the peripheral interface 1530. For example, the I/O subsystem 1540 may include a controller for coupling the peripheral interface 1530 and a peripheral device such as a monitor, a keyboard, a mouse, a printer, and a touch screen or a sensor depending on a necessity. The I/O peripheral devices may be coupled with the peripheral interface 1530 without using the I/O subsystem 1540.

The power circuit 1550 may supply a power to all of or a portion of components of a terminal. For example, the power circuit 1550 may include a power management system, at least one power source such as a battery and alternating circuit (AC), a charge system, a power failure detection circuit, a power converter or inverter, a power status indicator, or other components for creating, managing and distributing power.

The communication circuit 1560 enables communication with another computer system using at least one external port. Further, as described above, the communication circuit 1560 may enable communication with another computer system by including a radio frequency (RF) circuit and transmitting and receiving an RF signal, such as an electromagnetic signal.

According to an exemplary embodiment, a promotion platform system may include at least one processor 1510, a memory 1520, a peripheral interface 1530, an input/output (I/O) subsystem 1540, a power circuit 1550, and a communication circuit 1560. The communication circuit 560 comprises a registration request processing module, e.g., a registration request transceiver, configured to receive registration request signals from service provider terminals. Each of the registration request signals may include an identifier of a mobile application to be registered in a computer-implemented promotion platform of the promotion platform system.

The at least one processor 1510 may include a registration module, e.g., a register, configured to register an inventory App or a target App into the computer-implemented promotion platform. More specifically, the registration module may be configured to register a plurality of different mobile applications to the computer-implemented promotion platform based on the registration request signals. Further, the at least one processor 1510 may include a promotion matching module configured to determine a target application associated with a first application (e.g., an inventory App) and a content item for a user to enter the computer-implemented promotion platform through the first application.

The at least one processor 1510 may include a display controller to control the I/O subsystem 1540 such that the I/O subsystem 1540 or other displays can display an application (App) information screen to a user having entered a promotion platform through the first application among the plurality of mobile applications. The App information screen may include a content area and a promotion area associated with at least one of the plurality of mobile applications. The promotion area may be associated with the target application, and the content area may be associated with the content item.

The display controller may display information data of the first application on the App information screen as a compensation for the first application that has allowed the user to enter the computer-implemented promotion platform. Further, the promotion platform system may transmit information about the compensation to a user terminal executing the first application and displaying the App information screen in response to a user's input to retrieve the App information screen through the first application. The promotion platform system may also transmit analytic information including user entry to the promotion platform through the first application, user's subsequent activities in the promotion platform to at least one of the first application and a target application associated with the first application.

The display controller may display retargeting information on the content area. At least one of the number of display of the retargeting information and the number of clicks on the retargeting information may be calculated by the computer-implemented promotion platform. Revenues may be calculated based on the at least one of the number of display of the retargeting information and the number of clicks on the retargeting information. The at least one processor 1510 may include a revenue distributor to determine distribution amounts of revenues acquired through the retargeting information to the plurality of mobile applications, and to distribute the revenues based on the determined distribution amounts. The retargeting information may be displayed on App information screens of a plurality of inventory Apps. For example, retargeting information may be displayed on a second row of an App information screen associated with a first inventory App and a fourth row of an App information screen associated with a second inventory App. Based on the displayed location (e.g., the second row, the fourth row, etc.), the number of clicks on the retargeting information displayed on an App information screen associated with the respective inventory App, the number of users entered in the App information screen associated with the respective inventory App, and the like may be tracked to generate the analytic information and to determine the distribution amounts of the revenues generated from the retargeting information.

Further, the display controller may display retargeting information to a user having revisited the computer-implemented promotion platform based on a user reaction to external information displayed on the App information screen and a tracking log. For example, retargeting information may be rearranged in different rows, columns in an App information screen associated with an inventory App or may be relocated to another App information screen associated with a different inventory App based on the analytic information, a user reaction to external information displayed on the App information screen and a tracking log.

Further, the display controller may display external information, such as the retargeting information, based on at least one of a level of user interest and a similarity between pieces of external information. The display controller may also display information data of the target application based on a popularity of the target application among the mobile applications. The popularity of the target application may be determined based on at least one of the number of users having entered the computer-implemented promotion platform through the target application and the number of clicks occurred on the target application.

The exemplary embodiment illustrated in FIG. 15 is only one of various examples of a computer system. The computer system 1500 may have a configuration or an arrangement by eliminating a portion of the components illustrated in FIG. 15, further including components not illustrated in FIG. 15, or coupling two or more components. For example, a computer system for a communication terminal of a mobile environment may further include a touch screen, a sensor, and the like, in addition to the components of FIG. 15. A circuit for RF communication using a variety of communication methods, for example, wireless fidelity (Wi-Fi), 3^{rd} generation (3G), long term evolution (LTE), Bluetooth, near field communication (NFC), and ZigBee, may be included in the communication circuit 1560. Components that can be added in the computer system 1500 may be configured as hardware that includes an integrated circuit specified for at least one signal processing or application, software, or a combination of hardware and software.

The methods according to one or more exemplary embodiments may be configured in a program instruction form executable through various computer systems and thereby recorded in non-transitory computer-readable media.

As described above, a promotion platform providing method and system enable mobile Apps to share user traffic and to be advertised free of charge to a user of another App by using a promotion platform, and may provide a compensation, such as game money associated with a corresponding mobile App, to a new user when the new user completes a mission associated with a promotion ongoing in the corresponding mobile App, thereby inducing a genuine user who continuously uses the App. Thus, it is possible to attract active users, that is, genuine users of a corresponding App.

Further, since retargeting information is provided to a new user and a revisiting user through the promotion platform, it may be possible to induce the new user to revisit a corresponding site and to induce an idle user not having visited the corresponding site during a long period of time after installing a corresponding App or joining in a membership of a corresponding App.

Also, since revenues acquired through retargeting are provided to service providers of inventory Apps, the service providers may aggressively induce their own users to enter the promotion platform, thereby activating the promotion platform.

The units described herein may be implemented using hardware components, software components, or a combination thereof. For example, a processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will be appreciated that a processing device may include multiple processing elements and multiple types of processing elements. For example, a processing device may include multiple processors or a processor and a controller. In addition, different processing configurations are possible, such as parallel processors.

The software may include a computer program, a piece of code, an instruction, or some combination thereof, for independently or collectively instructing or configuring the processing device to operate as desired. Software and data may be embodied permanently or temporarily in any type of machine, component, physical or virtual equipment, or computer storage medium or device capable of providing instructions or data to or being interpreted by the processing device. The software also may be distributed over network coupled computer systems so that the software is stored and executed in a distributed fashion. In particular, the software and data may be stored by one or more computer readable recording mediums.

The above-described exemplary embodiments may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tape; optical media such as CD ROM disks and DVDs; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in priority to perform the operations of the above-described exemplary embodiments, or vice versa.

While certain exemplary embodiments and implementations have been described herein, other embodiments and modifications will be apparent from this description. Accordingly, the invention is not limited to such embodiments, but rather to the broader scope of the presented claims and various obvious modifications and equivalent arrangements.

What is claimed is:

1. A method of providing a computer-implemented promotion platform by a promotion platform service providing apparatus, the method comprising:
receiving registration request signals from service provider terminals, the registration request signals each comprising an identifier of a mobile application to be registered in a computer-implemented promotion platform;
registering, at the computer-implemented promotion platform, a plurality of different mobile applications based on the registration request signals;
determining, at the computer-implemented promotion platform, a target application associated with a first application and a content item for a user to enter the computer-implemented promotion platform through the first application; and
displaying an application (App) information screen to the user having entered a promotion platform through the first application among the plurality of different mobile applications,
wherein the App information screen comprises a content area and a promotion area associated with at least one of the plurality of different mobile applications, and
wherein the promotion area is associated with the target application, and the content area associated with the content item.

2. The method of claim 1, wherein the displaying of the App information screen comprises displaying information data of the first application on the App information screen as a compensation for the first application that has allowed the user to enter the computer-implemented promotion platform.

3. The method of claim 1, wherein the displaying of the App information screen comprises displaying retargeting information on the content area, and
wherein at least one of a number of displays of the retargeting information and a number of clicks on the retargeting information is calculated by the computer-implemented promotion platform.

4. The method of claim 3, further comprising:
determining distribution amounts of revenues acquired through the retargeting information to the plurality of different mobile applications; and
distributing the revenues based on the determined distribution amounts.

5. The method of claim 1, wherein the displaying of the App information screen comprises displaying retargeting information to the user having revisited the computer-implemented promotion platform based on the user reaction to external information displayed on the App information screen and a tracking log.

6. The method of claim 1, wherein the displaying of the App information screen comprises displaying the App information screen by applying a weight to each of the mobile applications based on a number of users having entered the computer-implemented promotion platform through the respective mobile application.

7. The method of claim 1, wherein the displaying of the App information screen comprises displaying external information based on at least one of a level of user interest and a similarity between pieces of external information.

8. The method of claim 1, wherein the displaying of the App information screen comprises displaying information data of the target application based on a popularity of the target application among the mobile applications, and
wherein the popularity of the target application is determined based on at least one of a number of users having entered the computer-implemented promotion platform through the target application and a number of clicks on the target application.

9. The method of claim 1, wherein the user having entered the promotion platform through the first application receives, from the target application, a compensation according to performing an operation designated in a promotion of the target application among promotions of the plurality of different mobile applications displayed through the computer-implemented promotion platform.

10. The method of claim 1, wherein the computer-implemented promotion platform shares traffic of users of each of the different mobile applications.

11. The method of claim 1, wherein the first application provides a compensation to the user according to an entry into the computer-implemented promotion platform through the first application.

12. A non-transitory computer-readable storage medium comprising a program that, when executed by one or more processors of a computer-implemented promotion platform providing apparatus, causes the computer-implemented promotion platform providing apparatus to perform the method of claim 1.

13. A promotion platform system comprising:
a registration request transceiver configured to receive registration request signals from service provider terminals, the registration request signals each comprising an identifier of a mobile application to be registered in a computer-implemented promotion platform of the promotion platform system;
a register configured to register a plurality of different mobile applications to the computer-implemented promotion platform based on the registration request signals;
a processor comprising a promotion matching module configured to determine a target application associated with a first application and a content item for a user to enter the computer-implemented promotion platform through the first application; and
a display controller configured to display an application (App) information screen to the user having entered a promotion platform through the first application among the plurality of different mobile applications,
wherein the App information screen comprises a content area and a promotion area associated with at least one of the plurality of different mobile applications, and
wherein the promotion area is associated with the target application, and the content area associated with the content item.

14. The promotion platform system of claim 13, wherein the display controller is configured to display information data of the first application on the App information screen as a compensation for the first application that has allowed the user to enter the computer-implemented promotion platform.

15. The promotion platform system of claim 13, wherein the display controller is configured to display retargeting information on the content area, and
wherein at least one of a number of displays of the retargeting information and a number of clicks on the retargeting information is calculated by the computer-implemented promotion platform.

16. The promotion platform system of claim 15, further comprising:
a revenue distributor configured to determine distribution amounts of revenues acquired through the retargeting information to the plurality of different mobile applications, and to distribute the revenues based on the determined distribution amounts.

17. The promotion platform system of claim 13, wherein the display controller is configured to display retargeting information to a user having revisited the computer-implemented promotion platform based on the user reaction to external information displayed on the App information screen and a tracking log.

18. The promotion platform system of claim 13, wherein the display controller is configured to display the App information screen by applying a weight to each of the mobile applications based on a number of users having entered the computer-implemented promotion platform through the respective mobile application.

19. The promotion platform system of claim 13, wherein the display controller is configured to display external information based on at least one of a level of user interest and a similarity between pieces of external information.

20. The promotion platform system of claim 13, wherein the display controller is configured to display information data of the target application based on a popularity of the target application among the mobile applications, and
wherein the popularity of the target application is determined based on at least one of a number of users having entered the computer-implemented promotion platform through the target application and a number of clicks on the target application.
